(19) United States
(12) Patent Application Publication
(10) Pub. No.: US 2026/0094469 A1
(43) Pub. Date: Apr. 2, 2026

(54) IDENTIFICATION METHOD AND APPARATUS, DEVICE, MEDIUM AND PRODUCT

(71) Applicant: Beijing Zitiao Network Technology Co., Ltd., Beijing (CN)

(72) Inventor: Zhihong FU, Beijing (CN)

(21) Appl. No.: 19/253,620

(22) Filed: Jun. 27, 2025

(30) Foreign Application Priority Data
Sep. 30, 2024 (CN) 202411391289.4

(51) Int. Cl. G06V 40/16; G06V 10/48

(52) U.S. Cl. CPC G06V 40/172; G06V 10/48

(57) ABSTRACT

The present disclosure provides an identification method and apparatus, a device, a medium and a product. The method comprises: obtaining an image of a face including a target part; transforming the image of the face into a first image space according to a first transformation matrix to obtain a first transformed image, in which a pixel ratio of the face is as high as possible; and transforming the image of the face into a second image space according to a second transformation matrix to obtain a second transformed image, in which a pixel ratio of the target part is as high as possible; determining an identification result for a visible area of the face and an identification result for a visible area of the target part based on the first transformed image, the first transformation matrix, the second transformed image and the second transformation matrix.

### CROSS-REFERENCE TO RELATED APPLICATION(S)

This application claims priority to Chinese Application No. 202411391289.4 filed in Sep. 30, 2024, the disclosure of which is incorporated herein by reference in its entirety.

### FIELD

The present disclosure relates to the field of image processing techniques, in particular to an identification method and apparatus, a device, a medium and a product.

### BACKGROUND

For some scenarios, e.g., scenarios related to face effects or facial beautification etc., they have the following requirements of identifying visible areas of some parts, such as face, lip, oral cavity and the like, from a face image, to subsequent perform other processing (like enhancing lipstick effects) with these areas.

### SUMMARY

The present disclosure provides an identification method and apparatus, a device, a medium, and a product, to enhance the identification effects.

To realize the above purpose, the present disclosure proposes the following technical solutions:

The present disclosure provides an identification method, comprising: obtaining an image of a face including a target part; transforming the image of the face into a first image space according to a first transformation matrix to obtain a first transformed image, and transforming the image of the face into a second image space according to a second transformation matrix to obtain a second transformed image, wherein the first transformation matrix is determined based on facial key points of the image of the face and key points of the first image space, the key points of the first image space are used for describing cropping constraints of the face, the facial key points include key points of the target part, the second transformation matrix is determined based on key points of the target part and key points of the second image space, the key points of the second image space are used for describing cropping constraints of the target part, and a pixel ratio of the target part in the second transformed image is higher than a pixel ratio of the target part in the first transformed image; and determining an identification result for a visible area of the face and an identification result for a visible area of the target part based on the first transformed image, the first transformation matrix, the second transformed image, and the second transformation matrix

In one possible implementation, the identification result for the visible area of the face is obtained from transforming an area prediction result of the first transformed image back to an image space of the image of the face based on an inverse transformation matrix corresponding to the first transformation matrix, the area prediction result of the first transformed image is used for describing a position of the visible area of the face in the first transformed image; the identification result for the visible area of the target part is obtained from transforming an area prediction result of the second transformed image back to the image space of the image of the face based on an inverse transformation matrix corresponding to the second transformation matrix, the area prediction result of the second transformed image is used for describing a position of a visible area of the target part in the second transformed image.

In one possible implementation, the method further comprises: splicing the first transformed image with the second transformed image to obtain a spliced image; determining, based on the spliced image, an area prediction result of the first transformed image and an area prediction result of the second transformed image, wherein the area prediction result of the first transformed image is used to describe a position of the visible area of the face in the first transformed image and the area prediction result of the second transformed image is used to describe a position of the visible area of the target part in the second transformed image. Wherein determining the identification result for the visible area of the face and the identification result for the visible area of the target part based on the first transformed image, the first transformation matrix, the second transformed image, and the second transformation matrix includes: determining the identification result for the visible area of the face and the identification result for the visible area of the target part based on an area prediction result of the first transformed image, the first transformation matrix, an area prediction result of the second transformed image, and the second transformation matrix.

In one possible implementation, a width of the first transformed image is equal to a width of the second transformed image; and a height of the spliced image is determined based on a sum of a height of the first transformed image and a height of the second transformed image.

In one possible implementation, a width of the first transformed image is smaller than a height of the first transformed image.

In one possible implementation, a ratio of a height of the first transformed image to a height of the second transformed image is determined based on a ratio of a height of the face to a maximum value of a height of the target part, wherein the target part includes a plurality of shapes, different shapes have different heights, and a height of each of the shapes is not greater than a maximum value of a height of the target part.

In one possible implementation, the target part includes a lip and an oral cavity, and the identification result for the visible area of the target part includes an identification result for a visible area of the lip and an identification result for a visible area of the oral cavity.

In one possible implementation, the identification method is applied to a terminal device.

The present disclosure provides an identification apparatus, comprising: an obtaining unit, configured to obtain an image of a face including a target part; a transforming unit, configured to transform the image of the face into a first image space according to a first transformation matrix to obtain a first transformed image, and transform the image of the face into a second image space according to a second transformation matrix to obtain a second transformed image, wherein the first transformation matrix is determined based on facial key points of the image of the face and key points of the first image space, the key points of the first image space are used for describing cropping constraints of the face, the facial key points include key points of the target part, the second transformation matrix is determined based on key points of the target part and key points of the second image space, the key points of the second image space are used for describing cropping constraints of the target part, and a pixel ratio of the target part in the second transformed image is higher than a pixel ratio of the target part in the first transformed image; a determining unit, configured to determine an identification result for a visible area of the face and an identification result for a visible area of the target part based on the first transformed image, the first transformation matrix, the second transformed image, and the second transformation matrix.

The present disclosure provides an electronic device, comprising a processor and a memory; wherein the memory is used for storing instructions or computer programs; and the processor is used to execute the instructions or computer programs stored in the memory, to cause the electronic device to perform the identification method provided by the present disclosure.

The present disclosure provides a computer-readable medium stored with instructions or computer programs, wherein the instructions or computer programs, when running on a device, cause the device to perform the identification method provided by the present disclosure.

The present disclosure provides a computer program product comprising computer programs stored on a non-transitory computer-readable medium, the computer programs including program codes for performing the identification method provided by the present disclosure.

### BRIEF DESCRIPTION OF THE DRAWINGS

Brief introduction of the drawings required in the following description of the embodiments or the prior art are to be introduced simply below to more clearly explain the technical solutions according to the embodiments of the present disclosure or in the related art. It is obvious that the following drawings only illustrate some embodiments of the present disclosure and those skilled in the art also may obtain other drawings on the basis those illustrated ones without any exercises of inventive work.

FIG. 1 illustrates a flowchart of an identification method provided by the embodiments of the present disclosure.

FIG. 2 illustrates a schematic diagram of an identification method provided by the embodiments of the present disclosure.

FIG. 3 illustrates a structural diagram of an identification apparatus provided by embodiments of the present disclosure.

FIG. 4 illustrates a structural diagram of an electronic device provided by embodiments of the present disclosure.

### DETAILED DESCRIPTION OF EMBODIMENTS

How the above identification is implemented is an urgent technical problem to be solved.

It is found by study that some identification schemes specifically include: after a face image is obtained, it is subject to a facial detection processing to acquire a bounding box of the face, e.g., rectangular box and the like; the bounding box is then expanded outward to obtain a square box, such that the square box has a dimension greater than that of the bounding box and the geometric center of the square box overlaps with the geometric center of the bounding box; an image area within the square box is cut out from the face image to obtain a cropped image, so that the cropped image includes a face and its surrounding area; next, the cropped image is scaled to a target dimension, e.g., H×W, to obtain a scaled image; the scaled image is input to a pre-built machine learning model, such that the model can predict some parts, e.g., visible areas of face, lip and mouth etc., based on the scaled image.

It is also discovered that when the above described identification scheme is applied to a device with limited computation power, e.g., a terminal device, in consideration of real-time requirements and restrictions over computation power, it is required to ensure that the identification scheme meets the following constraints: the scaled image involved in the identification scheme has a relatively low image resolution (also known as dimension), e.g., 160×160 or 128×128, and the model used in the identification scheme is an ultra-lightweight neural network model, e.g., a model having a Floating Point Operations (FLOPs) lower than 20 MB.

It is further discovered that the identification schemes illustrated in the above two paragraphs are defective in following aspects: the visible areas of some parts have a low pixel ratio in the scaled image, for example, the visible area of the lip occupies has a pixel ratio of 3.125% in the scaled image; accordingly, in case of a low image resolution of the scaled image, many details in the visible areas of these parts would be missing and it is impossible for the model to accurately sense changes of edge pixel semantics of these parts. As a result, the prediction for the visible areas of these parts is less precise and the identification effects are not satisfactory.

In view of the above study, to better enhance the identification effects, the present application provides an identification method, the method comprising: first obtaining a face image, wherein a face presented in the face image comprises a target part, e.g., lip or oral cavity etc. ; then transforming the face image into a first image space based on a first transformation matrix to obtain a first transformed image, wherein a pixel ratio of the face in the first transformed image is as high as possible, such that the first transformed image can better describe the face presented in the face image with as little loss of facial details as possible; and transforming the face image into a second image space based on a second transformation matrix, to obtain a second transformed image, wherein a pixel ratio of the target part in the second transformed image is as high as possible, such that the second transformed image can better describe the target part presented in the face image with as little loss of details of the target part as possible; determining, based on the first transformed image, the first transformation matrix, the second transformed image and the second transformation matrix, an identification result for the visible area of the face and an identification result for the visible area of the target part, such that the identification result for the visible area of the face describes a position of the visible area of the face in the face image and the identification result for the visible area of the target part describes a position of the visible area of the target part in the face image.

Since the first transformation matrix is determined according to facial key points of the face image and key points of the first image space, and the key points of the first image space are provided to describe cropping constraints of the face, the first transformed image determined based on the first transformation matrix can better indicate a cropping result for the face in the face image, and thus the first transformed image contains little or no information that interferes with the face-related recognition, e.g., background information and the like. Further, the first transformed image can better describe the face presented in the face image with as little loss of facial details as possible. In such case, the visible area of the face determined based on the first transformed image is more accurate.

Moreover, since the second transformation matrix is determined according to key points of the target part and key points of the second image space, and the key points of the second image space are provided to describe cropping constraints of the target part, the second transformed image determined based on the second transformation matrix can better indicate a cropping result for the target part in the face image, and thus the second transformed image contains little or no information that interferes with recognition related to the target part, e.g., background information, other facial information and the like. Further, the target part has a higher pixel ratio in the second transformed image than in the first transformed image, so the second transformed image describes more detailed information of the target part than the first transformed image. Therefore, the visible area of the target part determined based on the second transformed image is more accurate.

It can be seen that, the present disclosure identifies visible areas of different parts by means of various image spaces, so as to effectively avoid defects caused by losing too many details of certain parts when the visible areas of different parts are identified using the same image space. The identification effects are therefore enhanced.

In addition, an executive subject of the identification method provided by the embodiments of the present disclosure is not restricted in the present application. For example, the identification method provided by the embodiments of the present disclosure may be applied to a device with limited computation power, e.g., a terminal device, wherein the terminal device may be a smartphone, a computer, a Personal Digital Assistant (PDA) and a tablet computer etc.

To facilitate those skilled in the art to better understand the solution of the present disclosure, the technical solutions in the embodiments of the present disclosure are to be described clearly and completely below with reference to the accompanying drawings. Apparently, the described embodiments merely are a part of the embodiments of the present disclosure, rather than all of them. All other embodiments obtained by those skilled in the art without requiring any exercises of inventive work on the basis of the embodiments of the present disclosure fall within the protection scope of the present disclosure.

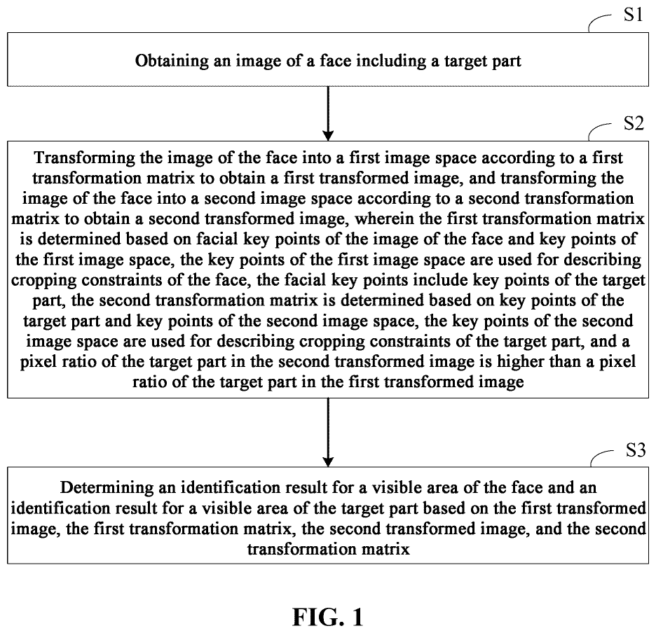

For a better understanding of the technical solutions provided by the present disclosure, the identification method proposed by the present disclosure is first illustrated with reference to some drawings. As shown in FIG. 1, the identification method provided by the embodiments of the present disclosure include S1-S3 below, wherein FIG. 1 illustrates a flowchart of the identification method according to embodiments of the present disclosure.

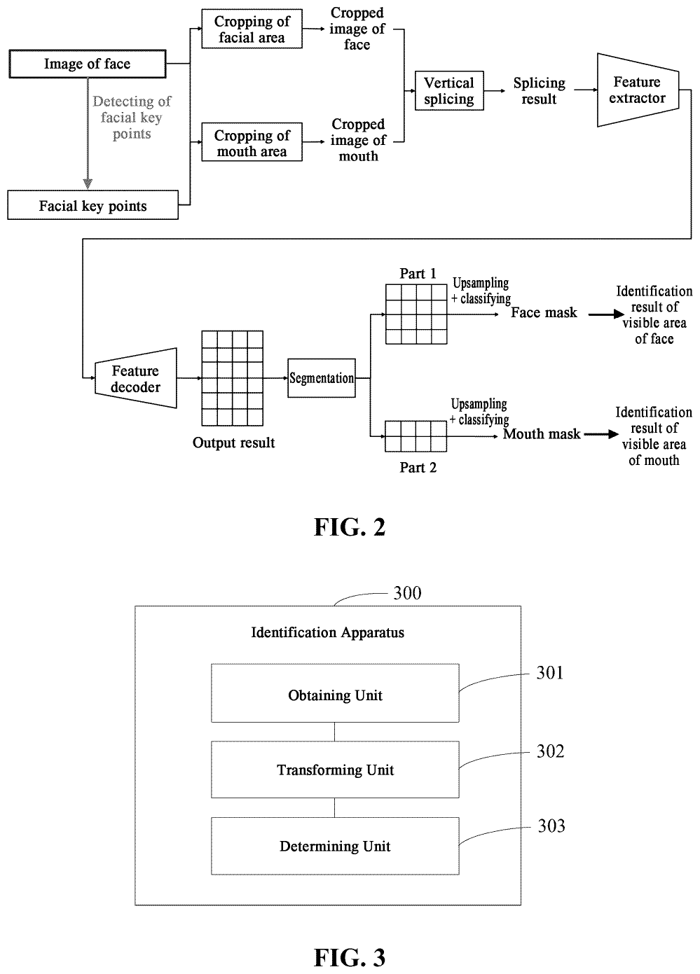

S1: obtaining an image of a face including a target part.

Wherein the face image refers to an image including the face, e.g., the face image as shown in FIG. 2. In one possible implementation, the face image may be an image having a dimension of H₁×W₁, where H₁ represents height of the face image and W₁ denotes width of the face image, and H₁×W₁ indicates an image resolution of the face image. It is noted that the relation between H₁ and W₁ is not restricted in the present disclosure. For example, they may be the same. For another example, they may be different.

Besides, the face image may at least satisfy the following constraints: the face in the face image includes the target part and the dimension of the face is greater than the dimension of the target part, so as to subsequently identify visible areas of the face and the target part, wherein the target part refers to a part in the face which needs to be processed for visible area identification.

Implementations of the target part are not restricted in the present application. For example, to better enhance flexibility, the target part may be defined based on the actual application scenario. Example 1: in some scenarios, e.g., scenarios focused on lip and oral cavity, the target part may include lip and oral cavity, so as to subsequently perform visible area identification at least with respect to the lip and the oral cavity. Example 2: in some scenarios, such as scenarios focused on mouth, the target part may include mouth, so as to subsequently perform visible area identification at least with respect to the mouth. Example 3: in some scenarios, e.g., scenarios focused on eyes, the target part may include the eye, so as to subsequently perform visible area identification at least with respect to the eye.

As such, in a possible implementation, the aforementioned target part may be used to describe any of five facial features, such as eyebrow, eye, ear, nose and mouth; besides, the target part may include at least one part, e.g., the following two parts, lip and oral cavity.

Further, implementations of the above face image are not restricted in the present disclosure. For example, in some scenarios, e.g., scenarios without obstructions, the face image may be used to describe a face in an unobstructed state, so the visible area of the face illustrated by the face image is the entire face and the visible area of the target part illustrated by the face image includes the entire target part. For another example, in some scenarios, e.g., scenarios with obstructions, the face image may be used to illustrate a face in an obstructed state, so the visible area of the face illustrated by the face image is an unobstructed portion of the face and the visible area of the target part illustrated by the face image includes an unobstructed portion of the target part.

It is noted that the above obstruction refers to a phenomenon that an opaque object is present between the face and the camera when the face image is being taken. In such case, the face image taken by the camera fails to present the part obstructed by the object, e.g., partial face area or partial mouth area etc. The face and/or target object presented in the face image is therefore incomplete. Further, the implementations of the object are not restricted in the present disclosure. For example, the object may be implemented by hand, hair or sunglasses.

Again, the approach for acquiring the above face image is not restricted in the present disclosure. For example, any image acquisition methods may be adopted, e.g., capture by camera.

Based on the above S1-related contents, in some scenarios, e.g., face effects scenarios, the terminal device with limited computation power receives the face image provided by the user via a certain input device and subsequently processes the face image, to obtain the visible area of the face and the visible area of the target part.

S2: transforming the image of the face into a first image space according to a first transformation matrix to obtain a first transformed image; and transforming the image of the face into a second image space according to a second transformation matrix to obtain a second transformed image, wherein the first transformation matrix is determined based on facial key points of the image of the face and key points of the first image space, and the key points of the first image space are used for describing cropping constraints of the face and the facial key points include key points of the target part; and the second transformation matrix is determined based on key points of the target part and key points of the second image space, the key points of the second image space is used for describing cropping constraints of the target part; and a pixel ratio of the target part in the second transformed image is higher than a pixel ratio of the target part in the first transformed image.

Wherein the first image space refers to an image space required for cropping a face from an image, and is used to describe constraints to be satisfied at the face cropping, e.g., the constraints to be met by the cropped image resulted from face cropping (such as cropped image of the face shown in FIG. 2). In such case, the first image space can depict some features of the face in the cropped image, e.g., the face is at the center position of the cropped image; an aspect ratio of the cropped image is a preset fixed value; the rolling (Roll) angle of the face presented in the cropped image is 0; the pixel ratio of the facial area in the cropped image is greater than a preset threshold (e.g., 80%). It is noted that the fixed value may be determined according to the actual application scenarios. For example, the fixed value may be 1 or 4/3.

Accordingly, in one possible implementation, the above first image space may be used to describe the face cropping constraints, wherein the cropping constraints indicate constraints to be satisfied when the face is cropped from an image and can represent the constraints to be met when the face in the image is mapped to the first image space. And, the cropping constraints are not restricted in the present disclosure. For example, with respect to the cropped image obtained through the face cropping, the cropping constraints may include at least one of the following constraints: the face being at the center position of the cropped image; an aspect ratio of the cropped image being a preset fixed value; the Roll angle of the face presented in the cropped image being 0; and the pixel ratio of the facial area in the cropped image being greater than a preset threshold.

According to the above two paragraphs, when the above first image space serves as the image space of the cropped image obtained from the face cropping, the first image space may at least satisfy the following constraints: pixel points at or near the center position of the first image space being used to describe the face (that is, the center pixel point of the first image space and the adjacent pixel points all being used to describe the face); the aspect ratio of the first image space being a preset fixed value (such as 1 or 4/3); the Roll angle of the face presented in the first image space being 0; a ratio of the number of the pixel points for describing the face in the first image space to the number of the pixel points in the first image space is greater than a preset threshold (e.g., 80%).

Further, in some scenarios, such as application scenarios with low computation load, the above image space may further satisfy the following constraints: the image resolution in the first image space does not exceed a predetermined maximum value of the image resolution for the application scenarios, so that the image having the first image space meets the image processing needs of the application scenarios.

Additionally, implementations of the above first image space are not restricted in the present disclosure. For example, an image space of a preset average face may be used for implementation, such that the first image space can represent features possessed by the average face, e.g., features described by the above face cropping constraints.

Moreover, representations of the above first image space are not restricted in the present disclosure. For example, the first image space may be represented in a two-dimensional image. Accordingly, in a possible implementation, the first image space may be implemented by a two-dimensional image of the preset average face, wherein the average face in the two-dimensional image satisfies the features described by the above face cropping constraints, such that the cropped image resulted from the face cropping by means of the two-dimensional image also satisfies the features, and thus the cropped image can better indicate the facial state.

The first transformation matrix refers to a transformation matrix required for mapping the face image to the first image space, e.g., affine transformation matrix etc. And, the first transformation matrix describes a corresponding relation between part or all of the pixel points in the face image (e.g., pixel points for describing the face) and the corresponding pixel points in the first image space.

In addition, the approach for obtaining the above first transformation matrix is not restricted in the present disclosure. For example, to enhance flexibility, the first transformation matrix may be determined based on facial key points of the face image and key points of the first image space, such that the first transformation matrix at least can describe a corresponding relation between the key points for describing the face in the face image and the key points for describing the face in the first image space. Accordingly, the first transformation matrix can indicate alignment between the key points in the image space of the face image and the key points in the first image space, and thus showing alignment between the pixel points in the image space of the face image and the pixel points in the first image space.

As to the facial key points of the above face image, e.g., facial key points shown in FIG. 2, the facial key points are used to describe the facial state presented in the face image, e.g., facial area position, facial shape, Roll angle of the face among other states; the approach for obtaining the facial key points is not restricted in the present disclosure. For example, any existing or future methods for detecting facial key points may be adopted for implementation.

For the key points of the above first image space, they are used to describe the facial state presented in the first image space, e.g., facial state of the average face, such that the key points of the first image space can describe the cropping constraints of the above face; besides, the implementations of the key points of the first image space are not restricted in the present disclosure; for example, the key points of the first image space may include key points of the face (e.g., average face) in the first image space. In addition, the approach for obtaining the key points of the first image space is not restricted in the present disclosure either. For example, the manual annotation may be used for implementation. For another example, any existing or further methods for detecting facial key points may be adopted for implementation.

In view of the above three paragraphs, in one possible implementation, the determination of the above first transformation matrix specifically includes: calculating, with a preset algorithm, e.g., least square method or any optimal solution search method etc., a transformation matrix when an error between the facial key points of the face image and the key points of the first image space is minimum, and using it as the first transformation matrix, to maximize a similarity between a state of the face in the result obtained from transforming the face image according to the first transformation matrix and the facial state described by the first image space. Moreover, the face described by the result can satisfy the cropping constraints of the face depicted by the first image space as much as possible, such that the face cropping implemented based on the first transformation matrix produces better effects.

The first transformed image indicates a result obtained by transforming the face image according to the first transformation matrix, such that the first transformed image can represent the state of the face described by the face image in the first image space. Moreover, the face described by the first transformed image can satisfy the cropping constraints of the face depicted by the first image space as much as possible, and the first transformed image can better represent the result obtained from the face cropping of the face image, e.g., the cropped image of the face shown in FIG. 2.

Moreover, in some scenarios, e.g., application scenarios with low computation load, the above first transformed image can at least meet the following constraints: the image resolution of the first transformed image is smaller than that of the face image, so the height of the first transformed image is smaller than that of the face image, and the width of the first transformed image is smaller than that of the face image. Accordingly, the first transformed image includes partial information in the face image.

It is found by study that as most faces have a height greater than a width, there are large background areas on the left and right sides of the face in the cropped image when the cropped image obtained by the face cropping is square-shaped. Accordingly, the cropped image carries much background information and the interference carried by the background information is also great.

Based on the above study, to better reduce the interference caused by the background information, the present disclosure also provides a possible implementation of the above first image space. In this implementation, the first image space may at least satisfy the following constraints: the width of the first image space is smaller than the height of the first image space, so that the first transformed image obtained by transforming the face image into the first image space also has a width smaller than the height. In such case, there are no or small background areas on the left and right sides of the face in the first transformed image, which can effectively reduce the interference caused by the background information.

It is also discovered by study that in case that the cropped image resulted from the face cropping is in the square shape, a ratio of the width of the face in the cropped image to the width of the cropped image is between 60% and 65% when the height of the cropped image is close to the height of the face in the cropped image.

Based on the above study, to better reduce the interference caused by the background information, the present disclosure also provides a possible implementation of the above first image space. In this implementation, the first image space may at least satisfy the following constraints: the height of the first image space is slightly greater than the height of the face in the first image space, and the aspect ratio of the first image space is 4/3, so that the first transformed image obtained by transforming the face image into the first image space has a height close to that of the face in the first image space and has an aspect ratio of 4/3. As such, the first transformed image contains fewer background areas, so as to effectively reduce the interference caused by the

### Background Information.

Accordingly, in one possible implementation, when the height of the first transformed image is H₂, the width of the first transformed image is three quarters of H₂; this can effectively reduce the pixel ratio of the background information in the first transformed image, increase the pixel ratio of the face in the first transformed image and lower the interference caused by the background information.

Based on the above disclosure of the first transformed image, for some scenarios, after the face image is obtained, the face image is first processed to detect facial key points, to obtain the facial key points of the face image, such that the facial key points can describe the facial state presented in the face image; then, the facial key points are aligned with the key points of the preset first image space (i.e., average face) to obtain the first transformation matrix, thereby minimizing the errors between the key points obtained from mapping the facial key points to the first image space according to the first transformation matrix and the key points of the first image space; accordingly, the first transformation matrix can indicate alignment between the pixel points in the image space of the face image and the pixel points in the first image space. Next, the first transformation matrix is considered as the affine transformation matrix, and the face image is transformed into the first image space by affine transformation, to obtain the first transformed image, such that the first transformed image can display the face based on the cropping constraints described by the first image space (e.g., facial dimension, face display position and the like). Accordingly, the first transformed image can better represent the facial area cropped from the face image and the first transformed image contains far less background information than the face imaged, which can effectively avoid the interference caused by the background information.

The second image space indicates an image space required for performing a target part cropping on an image, and is used to describe constraints to be satisfied at the target part cropping, e.g., the constraints to be met by the cropped image resulted from target part cropping (such as cropped image of the mouth shown in FIG. 2). In this way, the second image space can depict some features of the target part in the cropped image, e.g., the target part is at the center position of the cropped image; an aspect ratio of the cropped image is a preset fixed value; the Roll angle of the target part presented in the cropped image is 0; the pixel ratio of the target part area in the cropped image is greater than a preset threshold etc. It is noted that the fixed value may be determined depending on the actual application scenarios. For example, the fixed value may be ⅔.

Accordingly, in a possible implementation, the above second image space may be used to describe the cropping constraints of the target part, wherein the cropping constraints indicate constraints to be satisfied at the target part cropping on one image and can represent the constraints to be met when the target part in the image is mapped to the second image space. And the cropping constraints are not restricted in the present disclosure. For example, with respect to the cropped image obtained through the target part cropping, the cropping constraints may include at least one of: the target part being at the center position of the cropped image; an aspect ratio of the cropped image being a preset fixed value; the Roll angle of the target part presented in the cropped image being 0; the pixel ratio of the target part area in the cropped image being greater than a preset threshold.

According to the above two paragraphs, when the above second image space serves as the image space of the cropped image obtained from the target part cropping, the second image space may at least satisfy the following constraints: pixel points at or near the center position of the second image space being used to describe the target part (that is, the center pixel point of the second image space and the adjacent pixel points all being used to describe the target part); the aspect ratio of the second image space being a preset fixed value (such as ⅔); the Roll angle of the target part presented in the second image space being 0; a ratio of the number of the pixel points for describing target part in the second image space to the number of the pixel points in the second image space is greater than a preset threshold (e.g., 80%).

Further, in some scenarios, such as application scenarios with low computation load, the above second image space may further satisfy the following constraint: the image resolution in the second image space does not exceed a predetermined maximum value of the image resolution for the application scenarios, so that the image having the second image space meets the image processing needs of the application scenarios.

Additionally, implementations of the above second image space are not restricted in the present disclosure. For example, an image space of the preset average target part (e.g., average mouth) may be used for implementation, such that the second image space can represent features possessed by the average target part, e.g., features described by the cropping constraints of the above target part.

Moreover, representations of the above second image space are not restricted in the present disclosure. For example, the second image space may be represented in a two-dimensional image. Accordingly, in one possible implementation, the second image space may be implemented by a two-dimensional image of the preset average target part, wherein the average target part in the two-dimensional image satisfies the features described by the cropping constraints of the above target part, such that the cropped image resulted from the target part cropping by means of the two-dimensional image also satisfies the features and the cropped image can better indicate the state of the target part.

The second transformation matrix refers to a transformation matrix required for mapping the face image to the second image space, e.g., affine transformation matrix etc. And the second transformation matrix describes a corresponding relation between part or all of the pixel points in the face image (e.g., pixel points for describing the target part) and the corresponding pixel points in the second image space.

In addition, the approach for obtaining the above second transformation matrix is not restricted in the present disclosure. For example, to enhance flexibility, when the facial key points of the above face image include key points of the target part, the second transformation matrix may be determined based on key points of the target part and key points of the second image space, such that the second transformation matrix at least can describe a corresponding relation between the key points for describing the target part in the face image and the key points for describing the target part in the second image space. Accordingly, the second transformation matrix can indicate alignment between some key points in the image space of the face image and the corresponding key points in the second image space, and thus showing alignment between the pixel points in the image space of the face image and the pixel points in the second image space.

For the key points of the above target part, they refer to key points for describing the target part in the facial key points of the face image. As such, the key points of the target part can describe the state of the target part presented in the face image.

As to the key points of the above second image space, they are used to describe the state of the target part in the second image space, such that the key points of the second image space can describe the cropping constraints of the target part. And the implementations of the key points of the second image space are not restricted in the present disclosure; for example, the key points of the second image space may include key points of the target part (e.g., average mouth) in the second image space. In addition, the approach for obtaining the key points of the second image space is not restricted in the present disclosure either. For example, the manual annotation may be used for implementation. For another example, any existing or further methods for detecting key points may be adopted for implementation.

In view of the above three paragraphs, in one possible implementation, in a case that the facial key points of the above face image include key points of the target part, the determination of the above second transformation matrix specifically includes: calculating, with a preset algorithm, e.g., least square method or any optimal solution search method etc., a transformation matrix when an error between the key points of the target part and the key points of the second image space is minimum, and using it as the second transformation matrix, so as to maximize a similarity between a state of the target part in the result obtained from transforming the face image according to the second transformation matrix and the state of the target part described by the second image space. Moreover, the target part described by the result can satisfy the cropping constraints of the target part depicted by the second image space as much as possible, such that the target part cropping implemented based on the second transformation matrix can produce better effects.

The second transformed image indicates a result obtained by transforming the face image according to the second transformation matrix, such that the second transformed image can represent the state of the target part illustrated by the face image in the second image space. In this way, the target part described by the second transformed image can satisfy the cropping constraints of the target part depicted by the second image space as much as possible, and the second transformed image can better represent the result obtained from the target part cropping on the face image, e.g., the cropped image of the mouth shown in FIG. 2.

Moreover, in some scenarios, e.g., application scenarios with low computation load, the above second transformed image can at least meet the following constraints: the image resolution of the second transformed image is lower than that of the face image, so the height of the second transformed image is smaller than that of the face image and the width of the second transformed image is smaller than that of the face image. Accordingly, the second transformed image includes partial information in the face image.

As discovered by the study, if most target parts have a width greater than a height in some forms, to better reduce the interface caused by the background information, the present disclosure also provides one possible implementation of the above second image space. In this implementation, the second image space may at least satisfy the following constraints: the width of the second image space is determined by the width of the target part and the height of the second image space is determined according to the maximum value of the height of the target part (e.g., the height of the mouth when it opens), such that the aspect ratio of the second image space is determined based on a ratio of the maximum value of the height of the target part to the width of the target part. In this way, the second transformed image obtained from transforming the face image into the second image space contains as few pixel points for describing the background information as possible, so as to effectively reduce the interface caused by the background information.

As to the maximum value of the height of the target part, the maximum value of the height refers to the maximum height allowable for the target part. And when the target part includes a plurality of forms, e.g., the mouth opened in different degrees, the maximum value of the height may satisfy the following constraints: the height varies from one form to another, and the height of each form does not exceed the maximum value of the height of the target part. Accordingly, the maximum value of the height of the target part may be obtained from performing a maximum value analysis on the heights of the target part in various forms.

It is also found by study that, in order to reduce overheads of the computing resources, the above first transformed image may be spliced with the above second transformed image along a Y-axis direction, e.g., vertical splicing shown in FIG. 2, such that the spliced image contains as few useless pixel points (such as blank pixel points or background pixel points etc.) as possible. Accordingly, the computing resources consumed by processing the spliced image are lowered as much as possible.

Based on the above study, in order to reduce resource overheads, the present application also provides a possible implementation of the above second image space. In this implementation, the second image space may at least satisfy the following constraints: the width of the second image space is equal to the width of the above first image space, so that the second transformed image obtained by transformation into the second image space also has a width equal to that of the first transformed image obtained from transformation into the first image space. In this way, the second transformed image and the first transformed image can be spliced along the Y-axis direction, which is helpful to lower the resource overheads.

It is also discovered by study that if most target parts have a width greater than the height under some forms, a relative ratio of the maximum value of the height of the target part to the height of the face including the target part is almost fixed.

Based on the above study, to better reduce the interference caused by the background information, the present disclosure also provides a possible implementation of the above second image space. In this implementation, the second image space may at least satisfy the following constraints: a ratio of the height of the second image space to the height of the above first image space is a preset ratio, e.g., ½, such that a ratio of the height of the second transformed image obtained from transformation into the second image space to the height of the first transformed image obtained from transformation into the first image space is a preset ratio, wherein the preset ratio is obtained from analyzing a mass of face images, so that the preset value can better describe a high correlation between the face and the target part.

It is noted that, for the above illustrated preset ratio, when the width of the above second image space is equal to the width of the above first image and the ratio of the height of the second image space to the height of the first image space is the preset ratio, the preset ratio indicates a relative ratio of the height of the target part and the height of the face including the target part, e.g., 1:2, when the target part is enlarged to the width of the face.

In view of the above two paragraphs, in one possible implementation, the ratio of the height of the above first transformed image to the height of the above second transformed image may be determined based on a ratio of the height of the face to the maximum value of the height of the target part, such that the second transformed image can independently demonstrate the target part presented in the first transformed image. Accordingly, the second transformed image can show a local enlargement result for the target part in the first transformed image, so as to effectively overcome the defects induced by the low pixel ratio of the target part in the first transformed image and further enhance the identification results.

Based on the above disclosure of the second transformed image, for some scenarios, after the face image is obtained, the face image is first processed to detect facial key points, to obtain the facial key points of the face image, such that the facial key points include key points of respective parts in the face, e.g., key points of the target part; then, the key points of the target part are aligned with the key points of the preset second image space (i.e., average mouth) to obtain the second transformation matrix, thereby minimizing the errors between the key points obtained from mapping the key points of the target part to the second image space according to the second transformation matrix and the key points of the second image space; accordingly, the second transformation matrix can indicate alignment between the pixel points in the image space of the face image and the pixel points in the second image space. Next, the second transformation matrix is considered as the affine transformation matrix, and the face image is transformed into the second image space by affine transformation, to obtain the second transformed image, such that the second transformed image can display the target part based on the cropping constraints described by the second image space (e.g., facial dimension, display position of mouth and the like). Accordingly, the second transformed image can represent the area of the target part cropped from the face image and the information other than the target part information in the second transformed image is far little than the information other than the target part information in the face image. This can effectively avoid the interference caused by other information.

Based on the above S2-related contents, in some scenarios, in case that the above target part includes lip and oral cavity, or the target part includes mouth, after the face image is obtained, it is first processed to detect facial key points to obtain the facial key points of the face image, such that the facial key points include key points of respective parts in the face, e.g., key points of the mouth; then, the facial key points are aligned with the key points of the preset average face to perform the face cropping on the face image, e.g., the cropping of the facial area shown in FIG. 2, so as to obtain the first transformed image; accordingly, the first transformed image can represent the facial area cropped from the face image and describe the facial features presented in the face image with as little interference as possible. Besides, the key points of the mouth are aligned with the key points of the preset average mouth to crop the mouth from the face image, e.g., the cropping of the mouth area shown in FIG. 2, so as to obtain the second transformed image. As such, the second transformed image can represent the mouth area cropped from the face image and describe the mouth features presented in the face image with as little interference as possible.

S3: determining an identification result for a visible area of the face and an identification result for a visible area of the target part based on the first transformed image, the first transformation matrix, the second transformed image and the second transformation matrix.

Wherein the identification result for the visible area of the face is used to describe the position of the visible area of the face in the face image, such that the identification result for the visible area can indicate which pixel points in the face image are used for describing the visible area of the face.

The identification result for the visible area of the target part is used to describe the position of the visible area of the target part in the face image, such that the identification result for the visible area can indicate which pixel points in the face image are used for describing the visible area of the target part.

Accordingly, in one possible implementation, when the above target part includes lip and oral cavity, the identification result for the visible area of the target part includes an identification result for the visible area of the lip and an identification result for the visible area of the oral cavity, wherein the identification result for the visible area of the lip is used to describe the position of the visible area of the lip in the face image, such that the identification result for the visible area of the lip can indicate which pixel points in the face image are used for describing the visible area of the lip. The identification result for the visible area of the oral cavity is used to describe the position of the visible area of the oral cavity in the face image, such that the identification result for the visible area of the oral cavity can indicate which pixel points in the face image are used for describing the visible area of the oral cavity.

Moreover, implementations of the above S3 are not restricted in the present disclosure. For example, a prebuilt machine learning model having area identification function may be used for implementation.

Further, to better enhance the identification effects, the present disclosure also provides a possible implementation of the above S3. In this implementation, the S3 may specifically include: obtaining the identification result for the visible area of the face from transforming an area prediction result of the first transformed image back to an image space of the image of the face based on an inverse transformation matrix corresponding to the first transformation matrix, and obtaining the identification result for the visible area of the target part from transforming an area prediction result of the second transformed image back to an image space of the image of the face based on an inverse transformation matrix corresponding to the second transformation matrix.

As to the inverse transformation matrix corresponding to the above first transformation matrix, the transformation procedure described by the inverse transformation matrix is an inverse procedure of the transformation procedure described by the first transformation matrix, and vice versa. Accordingly, the inverse transformation matrix can represent a transformation matrix required for use when an image is transformed back to the original image space (e.g., the image space of the above face image) from the first image space, wherein the inverse transformation matrix is determined by an inverse process reasoning of the first transformation matrix. The approach for obtaining the inverse transformation matrix is not restricted in the present disclosure. For example, any existing or future methods for determining affine transformation matrix may be used for implementation.

As to the area prediction result for the above first transformed image, the area prediction result is used to describe the position of the visible area of the face in the first transformed image, such that the area prediction result can represent which pixel points in the first transformed image are used for describing the visible area of the face. In addition, the representations of the area prediction result are not restricted in the present disclosure; for example, the area prediction result may be represented by a binary mask. The approach for obtaining the area prediction result is also not restricted in the present disclosure. For example, any machine learning model may be used for implementation as long as it has the function of predicting the visible area of the face. Moreover, the implementations of the machine learning model are not restricted in the present disclosure. For example, the machine learning model may at least include feature extractors and feature decoders, arranged in sequence.

As to the inverse transformation matrix corresponding to the above second transformation matrix, the transformation procedure described by the inverse transformation matrix is an inverse procedure of the transformation procedure described by the second transformation matrix, and vice versa. Accordingly, the inverse transformation matrix can represent a transformation matrix required for use when an image is transformed back to the original image space (e.g., the image space of the above face image) from the second image space, wherein the inverse transformation matrix is determined by an inverse process reasoning of the second transformation matrix. The approach for obtaining the inverse transformation matrix is not restricted in the present disclosure. For example, any existing or future methods for determining affine transformation matrix may be used for implementation.

As to the area prediction result for the above second transformed image, the area prediction result is used to describe the position of the visible area of the target part in the second transformed image, such that the area prediction result can represent which pixel points in the second transformed image are used for describing the visible area of the target part. In addition, the representations of the area prediction result are not restricted in the present disclosure; for example, the area prediction result may be represented by a binary mask. The approach for obtaining the area prediction result is also not restricted in the present disclosure. For example, any machine learning model may be used for implementation as long as it has the function of predicting the visible area of the mouth (or the visible area of lip or the visible area of oral cavity). Moreover, the implementations of the machine learning model are not restricted in the present disclosure. For example, the machine learning model may at least include feature extractors and feature decoders arranged in sequence.

Based on the contents in the above five paragraphs, in some scenarios, the identification result for the visible area of the face may be determined according to the first transformation matrix and the area prediction result of the first transformed image; besides, the identification result for the visible area of the target part may be determined according to the second transformation matrix and the area prediction result of the second transformed image. Accordingly, the two determination procedures do not interfere with each other, which is helpful to reduce the overheads of the computation resources.

Furthermore, the above procedure for determining the area prediction result is not restricted in the present disclosure. For example, the area prediction result of the first transformed image may be obtained from performing a facial area detection processing on the first transformed image by a machine learning model, while the area prediction result of the second transformed image may be obtained from performing a target part area detection processing on the second transformed image by another machine learning model. The two detection procedures are independent of each other, which is beneficial to improve the detection effects.

To reduce the resource overheads, the above S3 may specifically include following steps 11-13.

Step 11: splicing the first transformed image with the second transformed image to obtain a spliced image.

It is noted that the implementations of the above step 11 are not restricted in the present disclosure. For example, any image splicing method may be used for implementation.

For another example, in some scenarios where the width of the target part is greater than its height in some forms, to reduce the computation load, when the width of the first transformed image is equal to the width of the second transformed image, the above step 11 may specifically include: splicing the first transformed image with the second transformed image along the height direction, to obtain a spliced image, wherein the height of the spliced image is equal to a sum of the height of the first transformed image and the height of the second transformed image; accordingly, the spliced image contains as little useless information as possible, e.g., background information, to effectively reduce the interference caused by the useless information.

Accordingly, in case that the above first transformed image has a height of H₂ and a width of H₂×¾ and the second transformed image has a height of H₃ (e.g., H₃=H₂/2) and a width of H₂×¾, the above spliced image has a height of H₂+H₃ and a width of H₂×¾.

Moreover, in some scenarios where the dimension of the spliced image is not fitted with the dimension of the machine learning model having area prediction function, the above step 11 may specifically include: first splicing the first transformed image with the second transformed image along the height direction, to obtain a spliced image; and then scaling the spliced image based on the dimension requirements of the model.

In view of the contents of the above three paragraphs, when the width of the first transformed image is equal to the width of the second transformed image, the height of the spliced image is determined according to a sum of the height of the first transformed image and the height of the second transformed image.

Step 12: determining, based on the above spliced image, an area prediction result of the first transformed image and an area prediction result of the second transformed image, wherein the area prediction result of the first transformed image is used to describe a position of the visible area of the face in the first transformed image and the area prediction result of the second transformed image is used to describe a position of the visible area of the target part in the second transformed image.

It is noted that the implementations of the above step 12 are not restricted in the present disclosure. For example, any machine learning models with area prediction function may be used for implementation.

For another example, the above step 12 may specifically include: segmenting the above spliced image to obtain the area prediction result of the first transformed image and the area prediction result of the second transformed image, wherein the image segmentation is used to determine positions of different areas in one image, e.g., the position of the visible area of the face, the position of the visible area of the lip, and the position of the visible area of the oral cavity etc.

It is noted that implementations of the image segmentations are not restricted in the present disclosure; for example, any existing or future machine learning models with image segmentation function may be used for implementation. Besides, the implementations of the machine learning model are not restricted. For example, the machine learning model may include feature extractors, feature decoders, segmentation modules and upsampling classification modules arranged in sequence.

Accordingly, in one possible implementation, in case that the above step 12 is implemented by means of a prebuilt machine learning model with image segmentation function or area prediction function, if the model includes feature extractors, feature decoders, segmentation modules and upsampling classification modules arranged in sequence, the step 12 may specifically include: after inputting the above spliced image into the machine learning model, performing the feature extraction on the spliced image by the feature extractors in the model to obtain a feature extraction result; then performing a feature decoding on the feature extraction result by the feature decoders in the model, to obtain a feature decoding result; subsequently segmenting the feature decoding result by the segmentation module in the model, to obtain a first feature map (part 1 shown in FIG. 2) for describing facial features and a second feature map (part 2 shown in FIG. 2) for describing features of the target part; finally upsampling and classifying the first feature map by the upsampling classification module in the model to obtain an area prediction result (e.g., face mask shown in FIG. 2) of the first transformed image; and upsampling and classifying the second feature map by the upsampling classification module in the model to obtain an area prediction result (e.g., mouth mask shown in FIG. 2) of the second transformed image.

Accordingly, in some scenarios, if the above spliced image has a height of H₂+H₃ and a width of H₂×¾, some data involved in the above paragraph have following characteristics: the above feature decoding result has a height of (H₂+H₃)/s and a width of (H₂×3)/(4×s), where s indicates a downsampling rate of shallow-layer features of the above feature decoder; the feature decoding result is horizontally segmented at y=H₂/s along the Y-axis direction to obtain the first feature map and the second feature map, such that the first feature map has a height of H₂/s and a width of (H₂×3)/(4×s) and the second feature graph has a height of H₃/s and a width of (H₂×3)/(4×s); the area prediction result of the above first transformed image has a height of H₂ and a width of H₂×¾ and the area prediction result of the second transformed image has a height of H₃ and a width of H₂×¾.

Step 13: determining an identification result for a visible area of the face and an identification result for a visible area of the target part based on the area prediction result of the first transformed image, the first transformation matrix, the area prediction result of the second transformed image and the second transformation matrix.

It is noted that the related contents of the above step S13 may refer to the above text.

Based on the contents related to the above steps 11-13, for some scenarios, e.g., application scenarios with low computation load, after the first transformed image and the second transformed image are obtained, the two images may first be spliced to obtain a splicing result, e.g., the splicing result shown in FIG. 2, such that the splicing result can describe the facial information carried by the first transformed image and the target part information carried by the second transformed image with as few pixel points as possible; then, the splicing result is input to the machine learning model with area prediction function, to obtain a first mask (e.g., the facial mask shown in FIG. 2) output by the model for representing the position of the visible area of the face in the first transformed image and a second mask (e.g., the mouth mask shown in FIG. 2) for indicating the position of the visible area of the target part in the second transformed image; afterwards, the first mask is transformed back to the image space of the face image according to the inverse transformation matrix corresponding to the first transformation matrix, to obtain an identification result for the visible area of the face; and the second mask is transformed back to the image space of the face image according to the inverse transformation matrix corresponding to the second transformation matrix, to obtain an identification result for the visible area of the target part.

Based on the above contents related to S1-S3, the identification method provided by the present disclosure first obtains the face image, wherein the face presented in the face image includes a target part, e.g., lip and oral cavity etc. ; then, the face image is transformed to the first image space according to the first transformation matrix to obtain the first transformed image, in which first transformed image, the pixel ratio of the face is as high as possible; accordingly, the first transformed image can better describe the face presented in the face image with as little loss of facial details as possible. The face image is then transformed into the second image space according to the second transformation matrix to obtain the second transformed image, in which second transformed image, the pixel ratio of the target part is as high as possible; as such, the second transformed image can better describe the target part presented in the face image with as little loss of facial details as possible. Subsequently, an identification result for the visible area of the face and an identification result for the visible area of the target part are determined based on the first transformed image, the first transformation matrix, the second transformed image and the second transformation matrix, such that the identification result for the visible area of the face is used to describe the position of the visible area of the face in the face image and the identification result for the visible area of the target part is provided to describe the position of the visible area of the target part in the face image.

Accordingly, the present disclosure identifies the visible areas of different parts with different image spaces, to effectively avoid the defects caused by loss of too many details of some parts when the visible areas of different parts are identified using the same image space and further enhance the identification results.

In view of the disclosure related to the above identification method, the technical solutions proposed by the present disclosure have following merits: \textcircled{1}the present disclosure identifies the visible area of the target part by means of an additional and independent image space, such that the technical solutions according to the present disclosure can achieve better effects while identifying the visible area of the target part under equivalent or similar computation loads. \textcircled{2}The dimension of the image space involved in the face cropping in the present application is determined according to the aspect ratio of the face, such that little useless information (e.g., background information) is required for identifying the visible area of the face with the image space. Accordingly, the technical solutions according to the present disclosure can achieve better effects with respect to identifying the visible area of the target part under equivalent or similar computation loads.

Based on the identification method provided by the embodiments of the present disclosure, embodiments of the present disclosure also provide an identification apparatus, which is explained and described below with reference to FIG. 3. FIG. 3 illustrates a structural diagram of an identification apparatus provided by embodiments of the present disclosure. It is noted that the technical details of the identification apparatus provided by the embodiments of the present disclosure may refer to the related contents of the above identification method.

As shown in FIG. 3, the identification apparatus 300 provided by the embodiments of the present disclosure comprise:
an obtaining unit 301 configured to obtain an image of a face including a target part;
a transforming unit 302 configured to transform the image of the face into a first image space according to a first transformation matrix to obtain a first transformed image; and transform the image of the face into a second image space according to a second transformation matrix to obtain a second transformed image, wherein the first transformation matrix is determined based on facial key points of the image of the face and key points of the first image space, the key points of the first image space are used for describing cropping constraints of the face and the facial key points include key points of the target part; and the second transformation matrix is determined based on key points of the target part and key points of the second image space, the key points of the second image space are used for describing cropping constraints of the target part; and a pixel ratio of the target part in the second transformed image is higher than a pixel ratio of the target part in the first transformed image;
a determining unit 303 configured to determine an identification result for a visible area of the face and an identification result for a visible area of the target part based on the first transformed image, the first transformation matrix, the second transformed image and the second transformation matrix.

In one possible implementation, the identification result for the visible area of the face is obtained from transforming an area prediction result of the first transformed image back to an image space of the image of the face based on an inverse transformation matrix corresponding to the first transformation matrix, the area prediction result of the first transformed image is used for describing a position of a visible area of the face in the first transformed image; the identification result for the visible area of the target part is obtained from transforming an area prediction result of the second transformed image back to an image space of the image of the face based on an inverse transformation matrix corresponding to the second transformation matrix, the area prediction result of the second transformed image is used for describing a position of a visible area of the target part in the second transformed image.

In one possible implementation, the determining unit 303 is specifically configured to: splice the first transformed image with the second transformed image to obtain a spliced image; determine, based on the spliced image, an area prediction result of the first transformed image and an area prediction result of the second transformed image, wherein the area prediction result of the first transformed image is used to describe a position of the visible area of the face in the first transformed image and the area prediction result of the second transformed image is used to describe a position of the visible area of the target part in the second transformed image; determine the identification result for the visible area of the face and the identification result for the visible area of the target part based on an area prediction result of the first transformed image, the first transformation matrix, an area prediction result of the second transformed image and the second transformation matrix.

In one possible implementation, a width of the first transformed image is equal to a width of the second transformed image; and a height of the spliced image is determined according to a sum of a height of the first transformed image and a height of the second transformed image.

In one possible implementation, a width of the first transformed image is smaller than a height of the

### First Transformed Image.

In one possible implementation, a ratio of a height of the first transformed image to a height of the second transformed image is determined based on a ratio of a height of the face to a maximum value of a height of the target part, wherein the target part includes a plurality of forms, different forms have various heights, and a height of each of the forms is not greater than a maximum value of a height of the target part.

In one possible implementation, the target part includes a lip and an oral cavity, and the identification result for the visible area of the target part includes an identification result for a visible area of the lip and an identification result for a visible area of the oral cavity.

In one possible implementation, the identification apparatus 300 is deployed on a terminal device.

In view of disclosure related to the above identification apparatus 300, the working principles of the identification apparatus 300 provided by the present application include: first obtaining a face image, wherein a face presented in the face image comprises a target part, e.g., lip or oral cavity etc. ; then transforming the face image into a first image space based on a first transformation matrix to obtain a first transformed image, in which first transformed image a pixel ratio of the face is as high as possible, such that the first transformed image can better describe the face presented in the face image with as little loss of facial details as possible; and transforming the face image into a second image space based on a second transformation matrix, to obtain a second transformed image, in which second transformed image a pixel ratio of the target part in the second transformed image is as high as possible, such that the second transformed image can better describe the target part presented in the face image with as little loss of details of the target part as possible; determining, based on the first transformed image, the first transformation matrix, the second transformed image and the second transformation matrix, an identification result for the visible area of the face and an identification result for the visible area of the target part, such that the identification result for the visible area of the face describes a position of the visible area of the face in the face image and the identification result for the visible area of the target part describes a position of the visible area of the target part in the face image. Accordingly, the identification apparatus 300 identifies the visible areas of different parts with different image spaces, to effectively avoid the defects caused by loss of too many details of some parts when the visible areas of different parts are identified using the same image space and thus enhancing the identification results.

In addition, embodiments of the present disclosure also provide an electronic device, wherein the device comprises a memory for storing instructions or computer programs, and a processor for executing the instructions or computer programs in the memory, causing the electronic device to execute any one implementation of the identification method provided by the embodiments of the present disclosure.

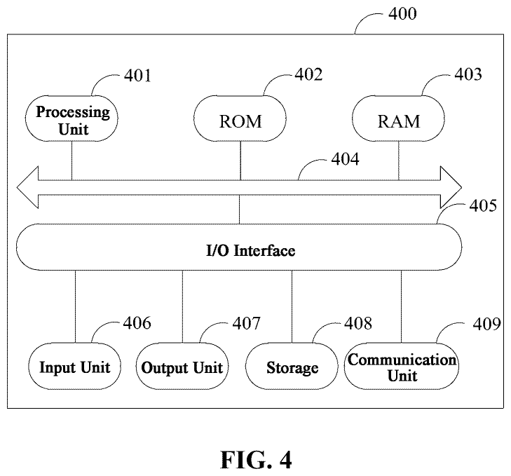

FIG. 4 illustrates a structural diagram of an electronic device 400 adapted to implement embodiments of the present disclosure. Terminal devices in the present disclosure may include, but not limited to, mobile terminals, such as mobile phones, notebooks, digital broadcast receivers, PDA (Personal Digital Assistant), PAD (Portable Android Device), PMP (Portable Multimedia Player) and vehicle terminals (such as car navigation terminal) and fixed terminals, e.g., digital TVs and desktop computers etc. The electronic device shown in FIG. 4 is just an example and will not put any restrictions on the functions and application ranges of the embodiments of the present disclosure.

According to FIG. 4, the electronic device 400 may include a processing unit (e.g., central processor, graphic processor and the like) 401, which can execute various suitable actions and processing based on the programs stored in the read-only memory (ROM) 402 or programs loaded in the random-access memory (RAM) 403 from a storage 408. The RAM 403 can also store all kinds of programs and data required by the operations of the electronic device 400. Processing unit 401, ROM 402 and RAM 403 are connected to each other via a bus 404. The input/output (I/O) interface 405 is also connected to the bus 404.

Usually, input unit 406 (including touch screen, touchpad, keyboard, mouse, camera, microphone, accelerometer, gyroscope and like) and output unit 407 (including liquid crystal display (LCD), speaker and vibrator etc.), storage 408 (including tape and hard disk etc.) and communication unit 409 may be connected to the I/O interface 405. The communication unit 409 may allow the electronic device 400 to exchange data with other devices through wired or wireless communications. Although FIG. 4 illustrates the electronic device 400 having various units, it is to be understood that it is not a prerequisite to implement or provide all illustrated units. Alternatively, more or less units may be implemented or provided.

In particular, based on embodiments of the present disclosure, the process depicted above with reference to the flowchart may be implemented as computer software programs. For example, the embodiments of the present disclosure include a computer program product including computer programs carried on a non-transitory computer readable medium, wherein the computer programs include program codes for executing the method demonstrated by the flowchart. In these embodiments, the computer programs may be loaded and installed from networks via the communication unit 409, or installed from the storage 408, or installed from the ROM 402. The computer programs, when executed by the processing unit 401, performs the above functions defined in the method according to the embodiments of the present disclosure.

The electronic device provided by the embodiments of the present disclosure and the method according to the above embodiments belong to the same inventive concept. The technical details not elaborated in these embodiments may refer to the above embodiments. Besides, these embodiments and the above embodiments achieve the same advantageous effects.

Embodiments of the present disclosure provide a computer-readable medium stored with instructions and computer programs therein, wherein when the instructions or computer programs are run on the device, the device is caused to execute any implementation of the identification method provided by the embodiments of the present disclosure.

It is noted the above disclosed computer readable medium may be computer readable signal medium or computer readable storage medium or any combinations thereof. The computer readable storage medium for example may include, but not limited to, electric, magnetic, optical, electromagnetic, infrared or semiconductor systems, apparatus or devices or any combinations thereof. Specific examples of the computer readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof. In the present disclosure, the computer readable storage medium may be any tangible medium that contains or stores programs. The programs may be utilized by instruction execution systems, apparatuses or devices in combination with the same. In the present disclosure, the computer readable signal medium may include a data signal propagated in baseband or as part of a carrier wave, carrying computer readable program codes therein. Such propagated data signals may take many forms, including but not limited to, electromagnetic signals, optical signals, or any suitable combinations thereof. The computer readable signal medium may also be any computer readable medium in addition to the computer readable storage medium. The computer readable signal medium may send, propagate, or transmit programs for use by or in connection with instruction execution systems, apparatuses or devices. Program codes contained on the computer readable medium may be transmitted by any suitable media, including but not limited to: electric wires, fiber optic cables and RF (radio frequency) etc., or any suitable combinations thereof.

In some implementations, clients and servers may communicate with each other via any currently known or to be developed network protocols, such as HTTP (Hyper Text Transfer Protocol) and interconnect with digital data communications in any forms or media (such as communication networks). Examples of the communication networks include Local Area Network (LAN), Wide Area Network (WAN), internet work (e.g., Internet) and end-to-end network (such as ad hoc end-to-end network), and any currently known or to be developed networks.

The above computer readable medium may be included in the aforementioned electronic device or stand-alone without fitting into the electronic device.

The above computer readable medium bears one or more programs. When the above one or more programs are executed by the electronic device, the electronic device is enabled to execute the above method.

Computer program instructions for executing operations of the present disclosure are written in one or more programming languages or combinations thereof. The above programming languages include, but not limited to, object-oriented programming languages, e.g., Java, Smalltalk, C++ and so on, and traditional procedural programming languages, such as “C” language or similar programming languages. The program codes can be implemented fully on the user computer, partially on the user computer, as an independent software package, partially on the user computer and partially on the remote computer, or completely on the remote computer or server. In the case where remote computer is involved, the remote computer can be connected to the user computer via any type of networks, including local area network (LAN) and wide area network (WAN), or to the external computer (e.g., connected via Internet using the Internet service provider).

The flow chart and block diagram in the drawings illustrate system architecture, functions and operations that may be implemented by system, method and computer program product according to various implementations of the present disclosure. In this regard, each block in the flow chart or block diagram can represent a module, a part of program segment or code, wherein the module and the part of program segment or code include one or more executable instruction for performing stipulated logic functions. In some alternative implementations, it should be noted that the functions indicated in the block can also take place in an order different from the one indicated in the drawings. For example, two successive blocks can be in fact executed in parallel or sometimes in a reverse order dependent on the involved functions. It should also be noted that each block in the block diagram and/or flow chart and combinations of the blocks in the block diagram and/or flow chart can be implemented by a hardware-based system exclusive for executing stipulated functions or actions, or by a combination of dedicated hardware and computer instructions.

Units described in the embodiments of the present disclosure may be implemented by software or hardware. In some cases, the name of the unit/module should not be considered as the restriction over the unit per se.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

In the context of the present disclosure, machine readable medium may be tangible medium that may include or store programs for use by or in connection with instruction execution systems, apparatuses or devices. The machine readable medium may be machine readable signal medium or machine readable storage medium. The machine readable storage medium for example may include, but not limited to, electric, magnetic, optical, electromagnetic, infrared or semiconductor systems, apparatus or devices or any combinations thereof. Specific examples of the machine readable storage medium may include, but not limited to, electrical connection having one or more wires, portable computer disk, hard disk, random access memory (RAM), read-only memory (ROM), erasable programmable read only memory (EPROM or flash memory), fiber optics, portable compact disk read only memory (CD-ROM), optical storage device, magnetic storage device, or any suitable combinations thereof.

It is noted that the various embodiments in the description are described in a progressive manner, and each embodiment focuses on differences from other embodiments, and the same and similar parts of one embodiment may refer to another. Since the system or apparatus disclosed in the embodiments corresponds to the method disclosed in the embodiments, the system or apparatus is described in a simple manner and the similar parts may refer to the description of the method.

It should be appreciated that “at least one” in the present application refers to one or more and “a plurality of” indicates two or more. “And/or” describes an association between two associated objects, which may represent three relations. For example, “A and/or B” may indicate A only, B only and both A and B, where A and B may be singular or plural form. The symbol “/” generally suggests an “OR” relation between the objects linking by it. The term of “at least one of the following” or similar expression indicate any combinations of the following items, including any combinations consisting of one or more items. For instance, at least one of a, b or c may indicate: a; b; c; a and b; a and c; b and c; or a, b and c, where a, b and c may be in singular or plural form.

It is noted that relation terms, such as first, second and the like, only distinguish one entity or operation from a further entity or operation, without requiring or suggesting any actual relation or sequence among these entities or operations. Besides, the terms “include”, “contain” or other variants indicate non-exclusive inclusion, such that a procedure, method, object or device consisting of a number of elements not only include these elements, but also contain other elements not listed or inherent elements. Without further limitations, when it is described that “. . . includes one . . . ”, the procedure, method, object or device including this element may further contain other elements.

Steps of the method or the algorithm described with reference to the embodiments of the present disclosure may be implemented directly hardware, or software module executed by the processor or a combination thereof. The software module may be built in a random access memory (RAM), a read only memory (ROM), an electrically programmable ROM, a register, a hard disk, a movable disk, a CD-ROM or a storage medium in any other forms known in the art.

The above explanation of the disclosed embodiments enables those skilled in the art to fulfill or use the present disclosure. Many modifications to the embodiments may be obvious for those skilled in the art. General principles defined in the text also can be implemented in other embodiments without deviating from the spirit or scope of the present application. Hence, the present disclosure is not restricted to the embodiments illustrated here; instead, it may have a broadest scope consistent with the disclosed principles and inventive points.

I/We claim:

1. An identification method, comprising:
obtaining an image of a face including a target part;
transforming the image of the face into a first image space according to a first transformation matrix to obtain a first transformed image, and transforming the image of the face into a second image space according to a second transformation matrix to obtain a second transformed image, wherein the first transformation matrix is determined based on facial key points of the image of the face and key points of the first image space, the key points of the first image space are used for describing cropping constraints of the face, the facial key points include key points of the target part, the second transformation matrix is determined based on key points of the target part and key points of the second image space, the key points of the second image space are used for describing cropping constraints of the target part, and a pixel ratio of the target part in the second transformed image is higher than a pixel ratio of the target part in the first transformed image; and
determining an identification result for a visible area of the face and an identification result for a visible area of the target part based on the first transformed image, the first transformation matrix, the second transformed image, and the second transformation matrix.

2. The method of claim 1, wherein the identification result for the visible area of the face is obtained from transforming an area prediction result of the first transformed image back to an image space of the image of the face based on an inverse transformation matrix corresponding to the first transformation matrix, the area prediction result of the first transformed image is used for describing a position of the visible area of the face in the first transformed image; and
wherein the identification result for the visible area of the target part is obtained from transforming an area prediction result of the second transformed image back to the image space of the image of the face based on an inverse transformation matrix corresponding to the second transformation matrix, and the area prediction result of the second transformed image is used for describing a position of a visible area of the target part in the second transformed image.

3. The method of claim 1, further comprising:
splicing the first transformed image with the second transformed image to obtain a spliced image; and
determining, based on the spliced image, an area prediction result of the first transformed image and an area prediction result of the second transformed image, wherein the area prediction result of the first transformed image is used to describe a position of the visible area of the face in the first transformed image and the area prediction result of the second transformed image is used to describe a position of the visible area of the target part in the second transformed image;
wherein determining the identification result for the visible area of the face and the identification result for the visible area of the target part based on the first transformed image, the first transformation matrix, the second transformed image, and the second transformation matrix comprises:
determining the identification result for the visible area of the face and the identification result for the visible area of the target part based on an area prediction result of the first transformed image, the first transformation matrix, an area prediction result of the second transformed image, and the second transformation matrix.

4. The method of claim 3, wherein a width of the first transformed image is equal to a width of the second transformed image; and
wherein a height of the spliced image is determined based on a sum of a height of the first transformed image and a height of the second transformed image.

5. The method of claim 1, wherein a width of the first transformed image is smaller than a height of the first transformed image.

6. The method of claim 1, wherein a ratio of a height of the first transformed image to a height of the second transformed image is determined based on a ratio of a height of the face to a maximum value of a height of the target part, and wherein the target part includes a plurality of shapes, different shapes have different heights, and a height of each of the shapes is not greater than a maximum value of a height of the target part.

7. The method of claim 1, wherein the target part includes a lip and an oral cavity, and the identification result for the visible area of the target part includes an identification result for a visible area of the lip and an identification result for a visible area of the oral cavity; and/or
the identification method is applied to a terminal device.

8. An electronic device, comprising: a processor and a memory;
wherein the memory is used for storing instructions or computer programs; and
wherein the processor is used to execute the instructions or the computer programs stored in the memory, to cause the electronic device to
obtain an image of a face including a target part;
transform the image of the face into a first image space according to a first transformation matrix to obtain a first transformed image, and transform the image of the face into a second image space according to a second transformation matrix to obtain a second transformed image, wherein the first transformation matrix is determined based on facial key points of the image of the face and key points of the first image space, the key points of the first image space are used for describing cropping constraints of the face, the facial key points include key points of the target part, the second transformation matrix is determined based on key points of the target part and key points of the second image space, the key points of the second image space are used for describing cropping constraints of the target part, and a pixel ratio of the target part in the second transformed image is higher than a pixel ratio of the target part in the first transformed image; and
determine an identification result for a visible area of the face and an identification result for a visible area of the target part based on the first transformed image, the first transformation matrix, the second transformed image, and the second transformation matrix.

9. The electronic device of claim 8, wherein the identification result for the visible area of the face is obtained from transforming an area prediction result of the first transformed image back to an image space of the image of the face based on an inverse transformation matrix corresponding to the first transformation matrix, the area prediction result of the first transformed image is used for describing a position of the visible area of the face in the first transformed image; and
wherein the identification result for the visible area of the target part is obtained from transforming an area prediction result of the second transformed image back to the image space of the image of the face based on an inverse transformation matrix corresponding to the second transformation matrix, and the area prediction result of the second transformed image is used for describing a position of a visible area of the target part in the second transformed image.

10. The electronic device of claim 8, wherein the instructions or the computer programs further cause the electronic device to:
splice the first transformed image with the second transformed image to obtain a spliced image; and
determine, based on the spliced image, an area prediction result of the first transformed image and an area prediction result of the second transformed image, wherein the area prediction result of the first transformed image is used to describe a position of the visible area of the face in the first transformed image and the area prediction result of the second transformed image is used to describe a position of the visible area of the target part in the second transformed image;
wherein the instructions or the computer programs causing the electronic device to determine the identification result for the visible area of the face and the identification result for the visible area of the target part based on the first transformed image, the first transformation matrix, the second transformed image, and the second transformation matrix further cause the electronic device to:
determine the identification result for the visible area of the face and the identification result for the visible area of the target part based on an area prediction result of the first transformed image, the first transformation matrix, an area prediction result of the second transformed image, and the second transformation matrix.

11. The electronic device of claim 10, wherein a width of the first transformed image is equal to a width of the second transformed image; and
wherein a height of the spliced image is determined based on a sum of a height of the first transformed image and a height of the second transformed image.

12. The electronic device of claim 8, wherein a width of the first transformed image is smaller than a height of the first transformed image.

13. The electronic device of claim 8, wherein a ratio of a height of the first transformed image to a height of the second transformed image is determined based on a ratio of a height of the face to a maximum value of a height of the target part, and wherein the target part includes a plurality of shapes, different shapes have different heights, and a height of each of the shapes is not greater than a maximum value of a height of the target part.

14. The electronic device of claim 8, wherein the target part includes a lip and an oral cavity, and the identification result for the visible area of the target part includes an identification result for a visible area of the lip and an identification result for a visible area of the oral cavity; and/or
the identification electronic device is applied to a terminal device.

15. A non-transitory computer-readable medium stored with instructions or computer programs, wherein the instructions or computer programs, when running on a device, cause the device to:
obtain an image of a face including a target part;
transform the image of the face into a first image space according to a first transformation matrix to obtain a first transformed image, and transform the image of the face into a second image space according to a second transformation matrix to obtain a second transformed image, wherein the first transformation matrix is determined based on facial key points of the image of the face and key points of the first image space, the key points of the first image space are used for describing cropping constraints of the face, the facial key points include key points of the target part, the second transformation matrix is determined based on key points of the target part and key points of the second image space, the key points of the second image space are used for describing cropping constraints of the target part, and a pixel ratio of the target part in the second transformed image is higher than a pixel ratio of the target part in the first transformed image; and
determine an identification result for a visible area of the face and an identification result for a visible area of the target part based on the first transformed image, the first transformation matrix, the second transformed image, and the second transformation matrix.

16. The non-transitory computer-readable medium of claim 15, wherein the identification result for the visible area of the face is obtained from transforming an area prediction result of the first transformed image back to an image space of the image of the face based on an inverse transformation matrix corresponding to the first transformation matrix, the area prediction result of the first transformed image is used for describing a position of the visible area of the face in the first transformed image; and
wherein the identification result for the visible area of the target part is obtained from transforming an area prediction result of the second transformed image back to the image space of the image of the face based on an inverse transformation matrix corresponding to the second transformation matrix, and the area prediction result of the second transformed image is used for describing a position of a visible area of the target part in the second transformed image.

17. The non-transitory computer-readable medium of claim 15, wherein the instructions or the computer programs further cause the device to:
splice the first transformed image with the second transformed image to obtain a spliced image; and
determine, based on the spliced image, an area prediction result of the first transformed image and an area prediction result of the second transformed image, wherein the area prediction result of the first transformed image is used to describe a position of the visible area of the face in the first transformed image and the area prediction result of the second transformed image is used to describe a position of the visible area of the target part in the second transformed image;
wherein the instructions or the computer programs causing the device to determine the identification result for the visible area of the face and the identification result for the visible area of the target part based on the first transformed image, the first transformation matrix, the second transformed image, and the second transformation matrix further cause the device to:
determine the identification result for the visible area of the face and the identification result for the visible area of the target part based on an area prediction result of the first transformed image, the first transformation matrix, an area prediction result of the second transformed image, and the second transformation matrix.

18. The non-transitory computer-readable medium of claim 17, wherein a width of the first transformed image is equal to a width of the second transformed image; and
wherein a height of the spliced image is determined based on a sum of a height of the first transformed image and a height of the second transformed image.

19. The non-transitory computer-readable medium of claim 15, wherein a width of the first transformed image is smaller than a height of the first transformed image.

20. The non-transitory computer-readable medium of claim 15, wherein a ratio of a height of the first transformed image to a height of the second transformed image is determined based on a ratio of a height of the face to a maximum value of a height of the target part, and wherein the target part includes a plurality of shapes, different shapes have different heights, and a height of each of the shapes is not greater than a maximum value of a height of the target part.
